(19) United States
(12) Patent Application Publication
(10) Pub. No.: US 2008/0009232 A1
(43) Pub. Date: Jan. 10, 2008

(54) Machining plate with machining element

(75) Inventor: Hakan Thysell, Soderkoping (SE)

Correspondence Address: MERCHANT & GOULD PC, P.O. BOX 2903, MINNEAPOLIS, MN, 55402-0903, US

(73) Assignee: HTC SWEDEN AB, Soderkoping (SE)

(21) Appl. No.: 11/316,796

(22) Filed: Dec. 22, 2005

(30) Foreign Application Priority Data
Jan. 7, 2005 (SE) 0500032-8

(51) Int. Cl. B23F 21/03

(52) U.S. Cl. 451/548

(57) ABSTRACT

A machining plate carries at least one machining element for the grinding, polishing and/or cutting of a floor surface. The machining element is arranged in a recess in the machining plate. The recess is at least partially provided with an elastic lining, so that the machining element is resiliently secured in relation to the machining plate.

### FIELD OF THE INVENTION

The present invention relates to a machining plate which carries at least one machining element for the grinding, polishing and/or cutting of a floor surface.

### BACKGROUND OF THE INVENTION

When machining, that is to say primarily grinding and polishing but also cutting floor surfaces with the aim of producing a plane, smooth surface, a machining appliance is commonly used which carries one or more machining element-carrying machining plates, which in contact with the floor surface are made to perform a movement in a plane parallel thereto, so that a machining, that is to say grinding, polishing or cutting action is produced on the floor surface. Examples of such machining element-carrying machining plates are shown in EP-1 321 233 and in WO 2004/108352.

A disadvantage of known machining element-carrying machining plates is that the machining elements, especially when machining uneven surfaces, come to pieces, become detached from the machining plate or wear unevenly. In the event of an uneven pressure distribution over the machining plate, the machining plate and/or the floor surface may burn. This leads to the machining plate having to be replaced, but in some cases it also results in damage to the floor surface that is being machined.

### SUMMARY OF THE INVENTION

An object of the invention is therefore to provide an improved machining element-carrying machining plate, in which the risk of the machining elements coming to pieces, becoming detached or wearing unevenly is reduced. A further object is to provide a machining element-carrying machining plate which is easy to manufacture and which can be manufactured at low cost.

The invention is defined by the independent patent claim attached. Embodiments are set forth by the dependent patent claims attached and by the following description and the drawings.

A machining plate is therefore provided, which carries at least one machining element for grinding, polishing and/or cutting of a floor surface. The machining element is arranged in a recess in the machining plate, the recess being at least partially provided with an elastic lining, so that the machining element is resiliently secured in relation to the machining plate.

The term “elastic” signifies that the lining must have greater elasticity than the machining plate and the machining element, so that the springing action is basically produced entirely by the lining.

Arranging the machining element in an elastically lined recess in the machining plate gives the machining element a capacity to perform a springing movement relative to the machining plate, which results in a damping of the shocks that occur when the grinding element strikes against projections, irregularities, edges etc. in the floor surface. It also affords damping of vibrations which occur as a result of the engagement of the machining element with the floor surface.

The machining plate may be designed so that in use it is displaced in its main plane, basically parallel to a machined, basically plane surface.

The machining plate may have a basically plane first surface, the recess forming a depression in said first surface. The machining plate may carry a plurality of machining elements.

The recess may be defined by an edge surface and a bottom surface, and the lining extends over at least a part of at least one of said edge surface and said bottom surface, so that at least a part of said edge surface and/or said bottom surface is lined. In one embodiment the lining extends over the entire said edge surface and/or the entire said bottom surface.

The machining element may be frictionally secured in relation to the machining plate. In one embodiment the machining element is press-fitted in relation to the lining and/or the lining is press-fitted in relation to the recess.

The machining element may also be secured in relation to the lining by positive interlocking. According to one embodiment the machining element narrows in a direction outwards from the recess and at right angles to the main plane of the machining plate, and the machining element and the lining have interacting tapered surfaces for securing the machining element to the lining. According to another embodiment the edge surface of the machining element has a groove and the inner surface of the lining has a collar designed for engagement in the groove for securing the machining element to the lining.

The machining element may also be secured in relation to the lining and/or the lining may be secured in relation to the machining plate by adhesive means, preferably adhesive.

The machining element may comprise a matrix filled with grinding abrasives/polishing agents. Alternatively the machining element may comprise at least one cutting edge. As a further alternative, grinding abrasives/polishing agents may be applied to the surface of the machining element remote from the machining plate.

### BRIEF DESCRIPTION OF THE DRAWINGS

The machining plate will now be described in more detail with reference to the schematic drawings attached, in which

FIG. 1 shows a perspective view of a machining element-carrying machining plate according to the invention.

FIG. 2 shows a sectional view of the machining element-carrying machining plate according in FIG. 1.

FIG. 3 shows an enlarged sectional view of the area marked ‘C’ in FIG. 2.

FIGS. 4a-4c show a machining plate according to a first alternative embodiment.

FIGS. 5a-5c show a machining plate according to a second alternative embodiment.

### DETAILED DESCRIPTION OF EMBODIMENTS

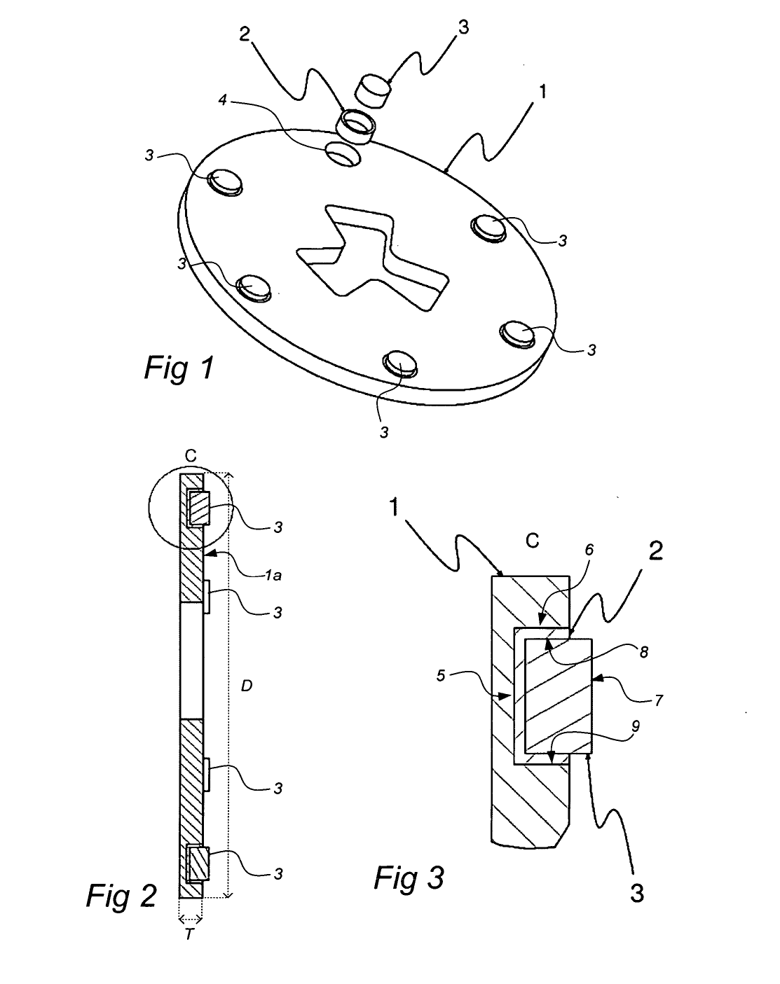

FIG. 1 shows a machining plate 1, which carries six machining elements. One of the machining elements 3 is detached from the machining plate 1.

The machining plate 1 comprises a basically plane, disc-shaped part with a thickness Y and a diameter D (FIG. 2). In the example shown the machining plate is circular, but it will be appreciated that it can also have other shapes, such as those shown in the aforementioned EP-1 321 233 and WO 2004/108352, for example. The machining plate 1 may be made from metal or plastics, preferably thermoplastics, depending on the demands imposed by the intended application.

The machining plate 1 may have fasteners for securing to a driven carrier (not shown), which produces a relative movement between the machining plate 1 and the floor surface. One or more machining plates 1 may be secured on a driven carrier and one or more driven carriers may form part of the machining appliance. For example, driven carriers may consist of driven planetary discs (not shown) on a driven sun disc (not shown).

The machining plate 1 has a recess 4 for securing the machining element 3. The shape of the recess 4 is adapted to suit the machining element that is to be placed therein. In the embodiment shown the recess is cylindrical, that is to say it has a circular bottom surface 5 and the edges 6 thereof are defined by a circumferential surface of a cylinder (FIG. 3). It will be appreciated that the bottom surface of the recess may be of any shape, for example, elliptical, square, rhomboid, rectangular, etc. Any number of machining elements 3 may be arranged on the machining plate 1.

It will further be noted that in the embodiment shown the recess 4 is a bottom hole made in the machining plate 1. According to an alternative embodiment a machining plate with through hole may be used, where necessary in conjunction with a further plate which provides a bottom for the hole. Such an embodiment may facilitate fitting of the machining element.

A lining 2 is arranged between the machining element 3 and the recess 4. An elastic material, that is to say a material having a low modulus compared to the machining plate and the machining element, high elasticity or deformability and elastic behaviour, is preferably selected as material in the lining. A rubber-elastic material which will withstand high temperatures, such as fluororubber, perfluororubber or silicone rubber, is preferably chosen. For machining at lower temperatures (lower pressure/speed, better cooling conditions), rubber-elastic material with inferior temperature stability may also be used. Thermoplastic elastomers such as urethane-based or amide-based TPE may also be used. Material for the lining 2 is selected on the basis of the forces and temperatures to which it is anticipated the machining element will be exposed.

The lining may be produced in a number of different ways.

According to one embodiment the lining is moulded or injection moulded as a separate part, which is fitted into the recess before or at the same time that the machining element is being fitted therein.

According to a second embodiment the machining element 3 is fitted into the recess 4, the lining material being injected into the gap that is formed between the machining element 3 and the recess 4. The lining material is then allowed to dry, set or cool, depending on which type of material is used.

According to a third embodiment the lining material 4 applied to the recess 4, following which the machining element 3 is inserted into the recess 4, so that the lining material is displaced and surrounds the machining element 3. According to this embodiment the quantity of lining material can be adjusted so that, by volume, the quantity of lining material applied to the recess 4 basically corresponds to the volume of the gap between the machining element 3 and the recess 4. The lining material is then allowed to dry, set or cool, depending on which type of material is used.

It will be appreciated that the recess 4 may be fully or partially lined. According to the embodiments described above the recess is largely fully lined. As an alternative it is possible to only partially line the recess. For example, the lining material may be applied only at isolated points to the bottom of the recess and to edge surfaces of the recess, on diametrically opposite sides of the machining element.

With a lining of this type it is possible to achieve a selectable spring amplitude. A suitable spring amplitude might be 1-2 mm, for example, but greater or lesser spring amplitudes can be achieved depending on how large the gap is made between the machining plate and the machining element and on which material is chosen for the lining.

The machining element 3 may be secured to the lining 2 and the lining 2 to the recess 4 by means of a press-fit.

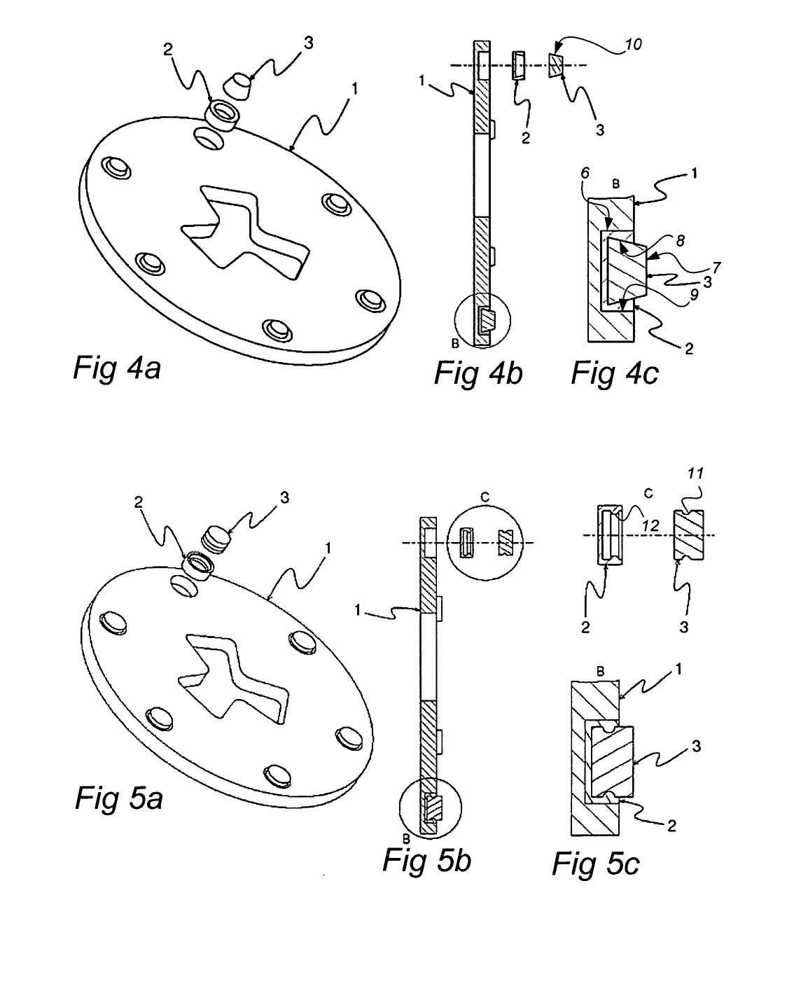

According to an embodiment shown in FIGS. 4a-4c the lining 2 and the machining element 3 may be formed so that they have interacting tapered surfaces 8, 10, which produce a positively interlocking and frictional connection between the machining element 3 and the lining 2.

According to one embodiment (not shown) the recess 4 may be made with an undercut, so that it narrows in the direction of the machining plate 1 towards the surface la facing the floor surface. Similarly the machining element 3 may be made to narrow outwards, for example in the shape of a truncated cone. If the machining plate is designed with through-recesses, such narrowing machining elements may be fitted by inserting them from the side of the machining plate 1 remote from the floor surface. Alternatively the size and shape of the recess 4, the lining 2 and the machining element 3 may be adapted so that the lining 2 and the machining element 3 can be pressed into the opening of the recess.

According to an embodiment shown in FIGS. 5a-5c the machining element may be provided with a peripheral groove 11 in the edge surface thereof. A corresponding lining may be provided with an inner salient groove or collar 12, so that when the machining element is inserted into the lining, the collar 12 meshes in the groove 11 and thereby produces a positively interlocking connection between the lining and the machining element.

According to another embodiment (not shown) the edge surfaces 8, 9 of the machining element and/or the lining are provided with one or more annular salient grooves, which are capable of acting together with one or more corresponding annular grooves in the lining 2 or the recess 4.

It will be appreciated that the fastening of the machining element 3 to the lining 2 and of the lining 2 to the recess 4 may be supplemented by adhesive means such as adhesive, double-sided tape etc.

The machining element 3 may be formed in a number of different ways.

According to one embodiment the machining element may be formed as a matrix containing grinding abrasives. The matrix may be a thermoplastic or thermosetting plastic material, or a metal, for example. The grinding abrasive may be diamond or polycrystalline diamond (PCD), for example, or other grinding abrasive suited to the purpose. The grain size of the grinding abrasive is selected according to the required intensity of the grinding or polishing action.

According to one embodiment the machining element 3 is of the so-called single-layer type, that is to say provided with grinding abrasive which is affixed to the surface of the machining element, for example by means of a thermosetting plastic. According to this embodiment the body of the machining element may comprise a matrix containing grinding abrasive or may comprise a backing block, having no grinding action, the function of which is to carry the grinding abrasive applied to the surface. A backing block, for example, may comprise a polymer or metal body, to the surface of which a thermosetting plastic material, for example phenol, melamine, urea or the like, has been applied, grinding abrasive such as diamond powder of selectable particle size having been distributed on the layer of thermoplastic material. If necessary, a further layer of thermoplastic material can then be applied on top of the layer of grinding abrasive.

According to a further embodiment the machining element may be designed with a cutting edge, for example in a manner similar to the cutting edge-carrying part in EP 1 321 233.

It will be appreciated that machining elements with grinding, polishing or cutting action can be combined on one and the same machining plate.

Machining element-carrying machining plates 1 as described above may be designed, according to what material is selected, for grinding, polishing or cutting of wooden floors, concrete floors, stone floors or similar floor surfaces.

1. Machining plate which carries at least one machining element for the grinding, polishing and/or cutting of a floor surface, wherein the machining element is arranged in a recess in the machining plate, the recess being at least partially provided with an elastic lining in engagement with a bottom surface of the machining element, so that the machining element is resiliently secured in relation to the machining plate.

2. Machining plate according to claim 1, wherein the machining plate is designed so that in use it is displaced in its main plane, basically parallel to a machined, basically plane surface.

3. Machining plate according to claim 1, wherein the machining plate has a basically plane first surface, the recess forming a depression in said first surface.

4. Machining plate according to claim 1, wherein the machining plate carries a plurality of machining elements.

5. Machining plate according to claim 1, wherein the recess is defined by an edge surface and a bottom surface, and that the lining extends over at least a part of at least one of said edge surface and said bottom surface.

6. Machining plate according to claim 5, wherein the lining extends over the entire said edge surface and/or the entire said bottom surface.

7. Machining plate according to claim 1, wherein the machining element is frictionally secured in relation to the machining plate.

8. Machining plate according to claim 7, wherein the machining element is press-fitted in relation to the lining and/or the lining is press-fitted in relation to the recess.

9. Machining plate according to claim 1, wherein the machining element is secured in relation to the lining by positive interlocking.

10. Machining plate according to claim 9, wherein the machining element narrows in a direction outward from a bottom surface of the recess toward the main plane of the machining plate, and the machining element and the lining have interacting tapered surfaces for securing the machining element to the lining.

11. Machining plate according to claim 9, wherein the edge surface of the machining element has a groove and that the inner surface of the lining has a collar designed for engagement in the groove for securing the machining element to the lining.

12. Machining plate according to claim 1, wherein the machining element is secured in relation to the lining and/or the lining is secured in relation to the machining plate by adhesive means, preferably adhesive.

13. Machining plate according to claim 1, wherein the machining element comprises a matrix filled with grinding abrasives/polishing agents.

14. Machining plate according to claim 1, wherein the machining element comprises at least one cutting edge.

15. Machining plate according to claim 1, wherein grinding abrasives/polishing agents are applied to the surface of the machining element remote from the machining plate.

16. Machining plate which carries at least one machining element for the grinding, polishing and/or cutting of a floor surface, wherein the machining element is arranged in a recess in the machining plate, the recess being at least partially provided with an elastic lining so that the machining element is resiliently secured in relation to the machining plate, wherein the recess is defined by an edge surface and a bottom surface, the lining extends over at least part of at least one of said edge surface and said bottom surface.

17. Machining plate according to claim 16, wherein the machining plate is designed so that in use it is displaced in its main plane, basically parallel to a machined, basically plane surface.

18. Machining plate according to claim 16, wherein the machining plate has a basically plane first surface, the recess forming a depression in said first surface.

19. Machining plate according to claim 16, wherein the machining plate carries a plurality of machining elements.

20. Machining plate according to claim 16, wherein the lining extends over the entire said edge surface or the entire said bottom surface.
